(19) United States
(12) Patent Application Publication
(10) Pub. No.: US 2016/0075868 A1
(43) Pub. Date: Mar. 17, 2016

(54) ENCAPSULATED PARTICLES OF SULPHATE-PROCESS TITANIUM DIOXIDE

(71) Applicants: Junyu CHEN, (US); Longlan CUI, Shanghai (CN); Juan LI, Shanghai (CN); Dan Danielle LIU, Shanghai (JP); Tao WANG, Shanghai (CN)

(72) Inventors: Junyu CHEN, Shanghai (CN); Longlan CUI, Shanghai (CN); Juan LI, Shanghai (CN); Dan Danielle LIU, Shanghai (CN); Tao WANG, Shanghai (CN)

(21) Appl. No.: 14/784,306

(22) PCT Filed: Apr. 15, 2013
(86) PCT No.: PCT/CN2013/074188

§ 371 Date: Oct. 14, 2015

(51) Int. Cl. C08L 33/08

(52) U.S. Cl. CPC C08L 33/08

(57) ABSTRACT

Provided is a pigment composition comprising
(i) a plurality of particles of sulfate-process titanium dioxide,
(ii) 0.1% to 25% by weight based on the weight of said particles of a water-soluble first polymer that comprises polymerized units of one or more sulfur acid monomer, and
(iii) 10% to 200% by weight based on the weight of said particles of a second polymer that at least partially encapsulates said particles.

There are two commercial processes for the manufacture of titanium dioxide particles, which are widely used as pigments in coatings and other products. The two processes are known as the sulfate process and the chloride process. The sulfate may be used in the production of either of the crystal forms anatase titanium dioxide and rutile titanium dioxide; the chloride process is normally only used in the production of rutile titanium dioxide. In the sulfate process, ore that contains titanium is dissolved in sulfuric acid to produce a solution that contains titanium sulfate and other metal sulfates, including iron sulfate. Further steps include, for example, a crystallization step, during which iron sulfate is partially or fully separated from the production stream, and then precipitation and calcination steps to produce intermediate titanium dioxide. Further subsequent steps usually include, for example finishing steps that include grinding to determine the size of the titanium dioxide particles.

It has been learned that coatings produced using sulfate-process titanium dioxide tend to have a more yellow appearance than coatings produced using chloride-process titanium dioxide, and such yellowness is undesirable. It is desired to provide materials and/or methods that allow the use of sulfate-process titanium dioxide and that reduce this tendency toward yellowness.

U.S. Pat. No. 8,283,404 describes a pigment particle that is at least partially encapsulated in polymer. U.S. Pat. No. 8,283,404 does not discuss sulfate-process titanium dioxide or the associated tendency toward yellowness in coatings.

The following is a statement of the invention.

The first aspect of the present invention is a pigment composition comprising (i) a plurality of particles of sulfate-process titanium dioxide, (ii) 0.1% to 25% by weight based on the weight of said particles of a water-soluble first polymer that comprises polymerized units of one or more sulfur acid monomer, and (iii) 10% to 200% by weight based on the weight of said particles of a second polymer that at least partially encapsulates said particles.

The following is a detailed description of the invention.

As used herein, the following terms have the designated definitions, unless the context clearly indicates otherwise.

As used herein, a composition is a dispersion when discrete particles are distributed throughout a continuous liquid medium. The continuous medium is an aqueous medium if the continuous medium contains 50% or more water, by weight based on the weight of the medium. When the continuous medium is an aqueous medium, the dispersion is an aqueous dispersion.

Sulfate-process titanium dioxide is titanium dioxide that has been produced using the sulfate process described herein above.

A “polymer,” as used herein, is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof.

Polymer molecular weights can be measured by standard methods such as, for example, size exclusion chromatography (SEC, also called gel permeation chromatography or GPC). Polymers have weight-average molecular weight (Mw) of 1000 or more. Polymers may have extremely high Mw; some polymers have Mw above 1,000,000; typical polymers have Mw of 1,000,000 or less. Some polymers are crosslinked, and crosslinked polymers are considered to have infinite Mw.

The glass transition temperature of a polymer is measured by differential scanning calorimetry using the midpoint method.

As used herein “weight of polymer” means the dry weight of polymer.

Molecules that can react with each other to form the repeat units of a polymer are known herein as “monomers.” The repeat units so formed are known herein as “polymerized units” of the monomer.

Vinyl monomers have the structure (I)

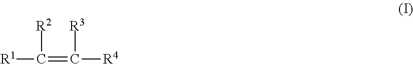

where each of R¹, R², R³, and R⁴ is, independently, a hydrogen, a halogen, an aliphatic group (such as, for example, an alkyl group), a substituted aliphatic group, an aryl group, a substituted aryl group, another substituted or unsubstituted organic group, or any combination thereof.

Vinyl monomers include, for example, styrene, substituted styrenes, dienes, ethylene, other alkenes, dienes, ethylene derivatives, and mixtures thereof. Ethylene derivatives include, for example, unsubstituted or substituted versions of the following: ethenyl esters of substituted or unsubstituted alkanoic acids (including, for example, vinyl acetate and vinyl neodecanoate), acrylonitrile, (meth)acrylic acids, (meth)acrylates, (meth)acrylamides, vinyl chloride, halogenated alkenes, and mixtures thereof. As used herein, “(meth)acrylic” means acrylic or methacrylic; “(meth)acrylate” means acrylate or methacrylate; and “(meth)acrylamide” means acrylamide or methacrylamide. “Substituted” means having at least one attached chemical group such as, for example, alkyl group, alkenyl group, vinyl group, hydroxyl group, carboxylic acid group, other functional groups, and combinations thereof. In some embodiments, substituted monomers include, for example, monomers with more than one carbon-carbon double bond, monomers with hydroxyl groups, monomers with other functional groups, and monomers with combinations of functional groups. (Meth)acrylates are substituted and unsubstituted esters or amides of (meth)acrylic acid.

As used herein, acrylic monomers are monomers selected from (meth)acrylic acid, esters of (meth)acrylic acid, esters of (meth)acrylic acid having one or more substituent on the ester group, (meth)acrylamide, N-substituted (meth)acrylamides, and mixtures thereof.

As used herein, vinylaromatic monomers are monomers selected from styrene, alpha-alkyl styrenes, substituted alkenes in which one or more substituent contains an aromatic group, and mixtures thereof.

An acid-functional monomer is a monomer has one or more acidic group, and at least one of the acidic groups remains intact after polymerization. A carboxyl-functional monomer is a monomer has one or more carboxyl group, and at least one of the carboxyl groups remains intact after polymerization.

As used herein, a sulfur-acid monomer is a vinyl monomer that has one or more sulfur acid groups. A sulfur acid group is a group selected from the following: —S(O)₂(OH), —OS(O)₂(OH), —OS(O)(OH), —S(O)(OH), mixtures thereof, and salts thereof.

As used herein, an amine monomer is a vinyl monomer that has one or amine group. An amine group is a residue selected from the following: —NH₂, —NHR⁶, and —N(R⁷)(R⁸), where each of R⁶, R⁷, and R⁸ is, independently, a substituted or unsubstituted alkyl group.

As used herein, an “acrylic” polymer is a polymer in which 30% or more of the polymerized units are selected from acrylic monomers and also in which 75% or more of the polymerized units are selected from the group consisting of acrylic monomers and vinylaromatic monomers; the percentages are by weight based on the dry weight of the polymer.

A compound is said herein to be water soluble if at least 5 grams of the compound can be dissolved in 95 grams of water at 25° C.

Emulsion polymerization is a process of forming a polymer that involves the use of monomer emulsions, which are dispersions of liquid monomer particles in an aqueous medium. The monomer emulsion is normally stabilized with one or more surfactant and/or one or more water-soluble polymer. Typically, a water-soluble initiator is used. Polymer particles form in the continuous medium apart from the monomer emulsion particles.

As used herein, a “two-stage” polymer is a polymer that is made by completing a first polymerization process (the “first stage”) involving a first monomer composition to produce a first stage polymer and then conducting a second polymerization process (the “second stage”) in the presence of the first stage polymer to produce a second stage polymer. The composition of the second stage polymer together with the first stage polymer is referred to as a two-stage polymer. A multi-stage polymer is produced by two or more such stages, in which each stage is completed before the next stage is begun and in which each stage after the first stage is performed in the presence of the previous stage polymer, and in which each stage after the first stage has a different composition from the previous stage polymer. A polymer made by a process in which no second stage is performed is called a single-stage polymer.

A binder is a polymer or pre-polymer that is present in a coating formulation. It is intended that, when the coating formulation is applied to a substrate surface, the binder becomes a polymer that forms a continuous film that adheres to the surface and that holds other ingredients of the formulation (such as, for example, pigment particles) in place.

A coalescent is an organic compound used in aqueous coating formulations. A coalescent is capable of absorbing into particles of a binder polymer, effectively reducing the Tg of the polymer, thus allowing particles of the polymer to coalesce after the coating formulation has been applied to a substrate surface.

When a ratio is said herein to be X:1 or greater, it is meant that the ratio is Y:1, where Y is greater than or equal to X. For example, if a ratio is said to be 3:1 or greater, that ratio may be 3:1 or 5:1 or 100:1 but may not be 2:1. Similarly, when ratio is said herein to be W:1 or less, it is meant that the ratio is Z:1, where Z is less than or equal to W. For example, if a ratio is said to be 15:1 or less, that ratio may be 15:1 or 10:1 or 0.1:1 but may not be 20:1.

The present invention involves the use of particles of sulfate-process titanium dioxide. Preferred is rutile titanium dioxide. Preferably the titanium dioxide particles have median particle size by weight of 0.2 micrometer or more. Preferably the titanium dioxide particles have median particle size by weight of 0.5 micrometer or less.

The titanium dioxide particles may optionally have at least one coating of one or more of silica, alumina, zinc oxide, and zirconia. For example, in certain embodiments titanium dioxide particles suitable for use in coatings of the present invention may have a coating of silica and a coating of alumina.

In some embodiments, particles of chloride-process titanium dioxide are present in the composition of the present invention. If particles of chloride-process titanium dioxide are present, they may or may not be at least partially encapsulated in the manner of the particles of sulfate-process titanium dioxide.

The present invention involves a water-soluble first polymer. The water-soluble first polymer of the present invention is soluble in water over a range of pH values that includes 1 to 5.

The water-soluble first polymer has polymerized units of one or more sulfur-acid monomer. Preferably, the number of polymerized units of sulfur-acid monomer in the water-soluble first polymer is 3 or more; more preferably 5 or more; more preferably 8 or more.

The water-soluble first polymer preferably has polymerized units of one or more amine monomer. Preferably, the number of polymerized units of amine monomers in the water-soluble first polymer is 2 or more; more preferably 3 or more; more preferably 4 or more.

Preferably, the mole ratio of amine groups to sulfur acid groups on the water-soluble first polymer is 10:1 or less; more preferably 3:1 or less; more preferably 1.5:1 or less. Preferably, the mole ratio of amine groups to sulfur acid groups on the water-soluble first polymer is 0.1:1 or greater; more preferably 0.25:1 or greater; more preferably 0.33:1 or greater.

Preferred sulfur-acid monomers for use in the water-soluble first polymer are sulfoethyl (meth)acrylate, sulfopropyl (meth)acrylate, styrene sulfonic acid, vinyl sulfonic acid, and 2-(meth)acrylamido-2-methyl propanesulfonic acid, mixtures thereof, and salts thereof.

Among amine monomers for use in the water-soluble first polymer, preferred are dialkylamino ethyl(meth)acrylates, monoalkylamino ethyl(meth)acrylates, dialkylamino propyl(meth)acrylates, monoalkylamino propyl(meth)acrylates, and mixtures thereof. In “dialkylamino” groups, the two alkyl groups may be the same as each other or may be different from each other. More preferred are dimethylamino ethyl(meth)acrylate, dimethylamino propyl(meth)acrylamide, and t-butylamino ethyl(meth)acrylate, and mixtures thereof.

Preferably, the water-soluble first polymer contains polymerized units of one or more additional vinyl monomer in addition to the sulfur-acid monomer and the optional amine monomer. Preferred additional monomers include dienes, alkenes, substituted alkenes, acrylic monomers, and mixtures thereof. More-preferred additional monomers are methyl methacrylate; ethyl acrylate; butyl acrylate; 2-ethylhexyl acrylate; acrylic acid; methacrylic acid; itaconic acid; styrene; vinyl acetate; hydroxyethyl (meth)acrylate; maleic acid; and maleic anhydride, and mixtures thereof.

Preferably, the water-soluble first polymer is an acrylic polymer.

Preferably, at least one water-soluble first polymer is used that contains no silane functional group; more preferably, every water-soluble first polymer in the present invention is a polymer that contains no silane functional group. Preferably, at least one water-soluble first polymer is used that contains no silicon atom; more preferably, every water-soluble first polymer in the present invention is a polymer that contains no silicon atom.

Preferably, the water-soluble first polymer has weight-average molecular weight of 1,000 or higher; more preferably 2,000 or higher; more preferably 3,000 or higher. Preferably, the water-soluble first polymer has weight-average molecular weight of 200,000 or lower; more preferably 50,000 or lower, more preferably 15,000 or lower; more preferably 10,000 or lower.

The water-soluble first polymer may be a random copolymer, a block polymer, or a comb polymer. Preferably, the water-soluble first polymer is a random copolymer.

The titanium dioxide particles may be dispersed in an aqueous medium with the water-soluble sulfur acid-functional polymer.

The present invention also involves a second polymer. The second polymer is preferably prepared by free radical emulsion polymerization of vinyl monomers in the presence of the pigment particle that has been dispersed in an aqueous medium. Preferably, the second polymer is an acrylic polymer.

In preferred embodiments the second polymer contains polymerized units of one or more water-soluble monomer. Preferred water soluble monomers are (meth)acrylamides, N-substituted (meth)acrylamides, hydroxyalkyl (meth)acrylates, acid-functional monomers, and mixtures thereof; more preferred are sulfur-acid monomers, carboxylic-functional monomers, and mixtures thereof. More preferred are 2-sulfoethyl (meth)acrylate, sulfopropyl (meth)acrylate, styrene sulfonic acid, vinyl sulfonic acid, 2-(meth)acrylamido-2-methyl propanesulfonic acid, acrylic acid, methacrylic acid, itaconic acid, mixtures thereof, and salts thereof. Among acrylamides and N-substituted (meth)acrylamides, preferred are acrylamide, diacetoneacrylamide, and mixtures thereof. Among hydroxyalkyl (meth)acrylates, preferred are 2-hydroxyethyl methacrylate, 2-hydroxyethyl acrylate, and mixtures thereof.

By “at least partially encapsulated” herein is meant that, for 50% or more of the titanium dioxide particles (based on the number of titanium dioxide particles), second polymer is in contact with at least a part of the surface of the titanium dioxide particle. The degree of encapsulation of the pigment particle may be determined using an electron micrograph. Determination of the degree of encapsulation does not include any contribution of first polymer, surfactant, dispersant, or the like.

By “X % encapsulated” herein is meant that, for 50% or more of the particles of titanium dioxide (by number of particles), X % or more of the surface area of the pigment particle is in contact with the second polymer, based on the total surface area of the particle. Preferably, the titanium dioxide particles are 50% encapsulated; more preferably 75% encapsulated, most preferably 100% encapsulated.

The average thickness of the second polymer encapsulant layer or shell on the titanium dioxide particle is preferably 500 nm or less; more preferably 200 nm or less; more preferably 150 nm or less; more preferably 120 nm or less. The average thickness of the second polymer encapsulant layer or shell on the titanium dioxide particle is preferably 20 nm or more; more preferably 40 nm or more.

A preferred process for making the pigment composition of the present invention contains the steps of (a) dispersing particles of sulfate-process titanium dioxide with from 0.1% to 25% by weight, based on the weight of the pigment particles, water-soluble sulfur acid-functional first polymer; and (b) performing an emulsion polymerization in the presence of the dispersed titanium dioxide particles to provide from 10% to 200%, by weight, based on the weight of said titanium dioxide particles, second polymer that at least partially encapsulates said dispersed pigment particles.

A step in this process is dispersing titanium dioxide particles in a medium, preferably an aqueous medium, with a water-soluble sulfur acid-functional polymer. This dispersion step may be effected by any means commonly used to disperse pigments in an aqueous medium, including, for example, grinding with a high speed dispersator, or grinding in media mills or ball mills. The amount of the water-soluble sulfur acid-functional polymer based on the weight of the pigment particles is preferably 0.1% or more; more preferably 0.25% or more; more preferably 0.5% or more. The amount of the water-soluble sulfur acid-functional polymer based on the weight of the pigment particles is preferably 25% or less; more preferably 10% or less; more preferably 5% or less; more preferably 2% or less.

The second polymer is preferably made by emulsion polymerization in the presence of dispersed particles of sulfate-process titanium dioxide. The emulsion polymerization can be carried out by methods well known in the polymer art, and includes multiple stage polymerization processes. Various synthesis adjuvants such as initiators, chain transfer agents, and surfactants are optionally utilized in the polymerization. Preferably, the emulsion polymerization is of a seeded type emulsion polymerization, with the dispersed pigment particles acting as the seeds. Preferably, at least one initiator is used that is water soluble. The polymerization may be run as a shot process, or by using multiple shots, or by continuously feeding in the monomer over time. The monomer may be added neat or emulsified in water with appropriate surfactants. For the process to be considered acceptable herein it must be capable of being effected at a final volume solids level of 40 vol % or higher, preferably at 45 vol %, with less than 1.0% by weight, based on the weight of total solids, of grit formation.

Preferably, when the second polymer is made by emulsion polymerization in the presence of dispersed particles of sulfate-process titanium dioxide, the result of that polymerization is an aqueous dispersion of polymer-encapsulated particles of titanium dioxide.

In a preferred embodiment of the present invention, the second polymer contains polymerized units of at least one sulfur acid-functional monomer. Preferred sulfur acid-functional monomers are sulfoethyl (meth)acrylate, sulfopropyl (meth)acrylate, styrene sulfonic acid, vinyl sulfonic acid, and 2-(meth)acrylamido-2-methyl propanesulfonic acid, salts thereof, and mixtures thereof. More preferably the sulfur acid-functional monomer is styrene sulfonic acid or its salt.

Preferably, the amount of polymerized units of sulfur acid-functional monomer in the second polymer is, by weight based on the dry weight of the second polymer, 0.1% or more; more preferably 0.25% or more; more preferably 0.5% or more. Preferably, the amount of polymerized units of sulfur acid-functional monomer in the second polymer is, by weight based on the dry weight of the second polymer, 20% or less; more preferably 10% or less; more preferably 5% or less; more preferably 2% or less.

If the second polymer is a single-stage polymer, the Tg is preferably −40° C. or higher; more preferably −30° C. or higher. If the second polymer is a single-stage polymer, the Tg is preferably 105° C. or lower; more preferably 80° C. or lower.

If the second polymer is a multi-stage polymer, then sulfur acid-functional monomer may be present in just one, in more than one, or in all of the individual stage polymers. If the second polymer is a multi-stage polymer, it is preferable that sulfur acid-functional monomer is present in the first polymer stage to be polymerized.

In preferred embodiments of the present invention (herein called “multistage” embodiments), the second polymer is a multi-stage polymer. Preferably, one of the stage polymers (herein called “polymer 2A”, regardless of the order in which the stages are polymerized) of the second polymer has Tg of 30° C. or higher; more preferably 45° C. or higher. Preferably, another of the stage polymers (herein called “polymer 2B”, regardless of the order in which the stages are polymerized) of the second polymer has Tg of 12° C. or lower; more preferably 0° C. or lower; more preferably −5° C. or lower.

In multistage embodiments, preferably the amount of polymer 2A is, by weight based on the weight of the pigment particles, 5% or more; more preferably 10% or more; more preferably 15% or more. In multistage embodiments, preferably the amount of polymer 2A is, by weight based on the weight of the pigment particles, 50% or less; more preferably 40% or less; more preferably 30% or less.

In multistage embodiments in which a polymer 2A is present, the weight of the “remainder” of the second polymer is the difference found by subtracting the dry weight of the second polymer minus the dry weight of polymer 2A. In multistage embodiments, the remainder of the second polymer is, by weight based on the weight of the pigment particles, 5% or more; more preferably 10% or more; more preferably 20% or more. In multistage embodiments in which a polymer 2A is present, the amount the remainder of the second polymer is, by weight based on the weight of the pigment particles, 150% or less; more preferably 125% or less; more preferably 100% or less.

One or more chain transfer agents are optionally used during polymerization of the second polymer. Preferred chain transfer agents are alcohols, mercaptans, polymercaptans, halogenated compounds, and mixtures thereof; more preferred are alkyl mercaptans, alkyl alcohols, halogenated compounds, and mixtures thereof. Among alkyl mecaptans, preferred are ethyl mercaptan, n-propyl mercaptan, n-butyl mercaptan, isobutyl mercaptan, t-amyl mercaptan, n-hexyl mercaptan, cyclohexyl mercaptan, n-octyl mercaptan, n-decyl mercaptan, n-dodecyl mercaptan; 3-mercaptoproprionic acid; 2-hydroxyethyl mercaptan, and mixtures thereof. Among alkyl alcohols, preferred are isopropanol, isobutanol, lauryl alcohol, t-octyl alcohol, and mixtures thereof. Among halogenated compounds, preferred are carbon tetrachloride, tetrachloroethylene, trichlorobromoethane, and mixtures thereof. Preferred are mercaptans.

In a preferred embodiment of the present invention the dispersed titanium dioxide particles are further stabilized with certain surfactants prior to the introduction of any monomers used to make the second polymer. These surfactants include the family of sulfosuccinic acid esters of the formula R¹¹—OC(O)CH₂CH(SO₃H)C(O)OR¹², where R¹¹ and R¹² may be alkyl, aryl, allyl, vinyl, styrenyl, or (meth)acryl, or H, and where R¹¹ and R¹² may be the same or different, with the exception that R¹¹ and R¹² may not both be H. Preferably, R¹¹ is C₆ to C₁₆ alkyl and R¹² is allyl. It has been discovered that use of such surfactants in the manner specified allows the emulsion polymerization to be run with much lower gel levels than result when no surfactant is used, or when other surfactants are used.

After formation of the encapsulated particles of sulfate-process titanium dioxide, the polymer-encapsulated particles are preferably provided as an aqueous dispersion. Alternately they may be provided as a solid in the form of a powder or pellet. The polymer encapsulated titanium dioxide particles may be removed from the aqueous medium of the emulsion polymerization by any appropriate technique including, for example, evaporative drying, spray drying, filtration, centrifugation, or coagulation. When the polymer-encapsulated pigment particles are provided as a solid, it is preferred that the Tg of the second polymer, or the Tg of the outermost stage polymer of the second polymer in the case where the second polymer is a multi-stage polymer, is above the temperature at which the polymer-encapsulated pigment particles will be stored, transported, and optionally processed prior to final application.

A preferred use for the pigment composition of the present invention is as an ingredient in a coating formulation. A coating formulation contains one or more binder polymer. The binder polymer may consist solely of the second polymer which encapsulates the titanium dioxide particles, or it may be a mixture of the encapsulating second polymer and one or more third polymers, or it may be one or more third polymer. Both the second polymer and third polymer are independently, alternatively a homopolymer, a copolymer, an interpenetrating network polymer, and a blend of two or more polymers or copolymers. Suitable third polymers include acrylic polymers, vinyl acetate polymers, vinyl/acrylic copolymers, styrene/acrylic copolymers, polyurethanes, polyureas, polyepoxides, polyvinyl chlorides, ethylene/vinyl acetate polymers, styrene/butadiene polymers, polyester polymers, polyethers, and the like, and mixtures thereof. Preferred are acrylic polymers.

The polymers which form the binder preferably have glass transition temperatures in the range of from −60° C. to 150° C. Preferred binders contain one or more polymer having Tg of 35° C. or lower. The coating composition optionally contains coalescents or plasticizers to provide the polymers with effective film formation temperatures at or below the temperature at which the coating is applied or cured, or the plastic part is formed. The level of optional coalescent is preferably in the range of from 0 to 40 wt %, based on the weight of the polymer solids.

A coating formulation made using the pigment composition of the present invention contains from 1 to 50 volume % pigment particles in the form of polymer-encapsulated pigment particles, preferably from 3 to 30 volume %, and more preferably from 5 to 20 volume %, based on the total dry volume of the coating formulation. The coating formulation contains from 10 to 99 volume % second and third polymer, preferably from 20 to 97 volume %, and more preferably from 25 to 80 volume %, based on the total dry volume of the coating formulation. The coating formulation contains from 0 to 70 volume % extender particles, preferably from 0 to 65 volume %, and more preferably from 0 to 60 volume %, based on the total dry volume of the coating formulation. The coating formulation contains from 0 to 20 volume % secondary pigment particles, preferably from 0 to 17 volume %, and more preferably from 0 to 15 volume %, based on the total dry volume of the coating formulation.

The coating formulation of the present invention optionally may also include other materials commonly found in coatings such as extenders, other polymers, hollow sphere pigments, solvents, coalescents, wetting agents, defoamers, rheology modifiers, crosslinkers, dyes, pearlescents, adhesion promoters, dispersants, leveling agents, optical brighteners, ultraviolet stabilizers, preservatives, biocides, and antioxidants.

Examples of “coatings” herein include inks, paper coatings; architectural coatings, such as interior and exterior house paints, wood coatings and metal coatings; coatings for leather; coatings and saturants for textiles and nonwovens; adhesives; powder coatings; and traffic paints such as those paints used to mark roads, pavements, and runways. Liquid coatings may be water or solvent based. When the coating is a powder coating, it is preferred that the Tg of the polymeric matrix, or the Tg of the outer most stage polymer of the polymeric matrix in the case where the polymeric matrix is a multiphase polymer, is above the temperature at which the coating will be stored, transported, and optionally processed prior to final application. When the coating is a solvent-based coating, it is preferred that the second polymer of the polymer-encapsulated pigment particles is not substantially soluble in the solvent or mixture of solvents utilized in the coating. In preferred coating formulations, the at least partially encapsulated particles of titanium dioxide are dispersed in an aqueous medium.

The following are examples of the present invention.

Some of the ingredients used in the present examples are as follows:

| Material | Chemical nature | Supplier |
|---|---|---|
| Primal ™ AC-261 acrylic | polyacrylate | Dow Chemical |
| latex binder | | Company |
| Primal ™ SF-155 acrylic | polyacrylate | Dow Chemical |
| latex binder | | Company |
| Ropaque ™ Ultra E | Polystyrene | Dow Chemical |
| polymer | hollow particles | Company |
| Rocima ™ 363 biocide | | Dow Chemical |
| | | Company |
| Rocima ™ 623 biocide | | Dow Chemical |
| | | Company |
| Kathon ™ LXE biocide | | Dow Chemical |
| | | Company |

The titanium dioxide grades used in the following examples were as follows:

| Material | Process | Supplier |
|---|---|---|
| TiPure ™ R-902+ | chloride | DuPont |
| Tiona ™ RCL 595 | chloride | Millenium |
| NTR-606 | sulfate | Ningbo Xinfu Titanium |
| | | Dioxide Co. Ltd. |
| NR-950 | sulfate | Nanjing Titanium |
| BLR-699 | sulfate | Henan Billion |
| ZR-960 | sulfate | Zhengjiang Titanium |

Further ingredients in the present examples were as follows:

| Material | Chemical nature | Supplier |
|---|---|---|
| Natrosol ™ 250 HBR | Hydrophobic modified | Aqualon |
| thickener | cellulose | |
| Acrysol ™ SCT-275 | Hydrophobically | Dow Chemical |
| | modified ethylene | Company |
| | oxide urethane | |
| Acrysol ™ RM-2020NPR | Hydrophobically | Dow Chemical |
| | modified ethylene | Company |
| | oxide urethane | |
| Propylene Glycol | Propylene glycol | |
| solvent | | |
| Ethylene Glycol | ethylene glycol | |
| solvent | | |
| Texanol ™ solvent | | Eastman Chemical |
| | | Company |
| COASOL ™ solvent | | Dow Chemical |
| | | Company |

Further materials were as follows.

| Material | Chemical nature | Supplier |
|---|---|---|
| AMP-95 base | 2-methyl-2-amino- | Dow Chemical |
| | propanol | Company |
| Orotan ™ 1124 dispersant | Hydrophilic modified | Dow Chemical |
| | polyacid Copolymer | Company |
| Orotan ™ 731A dispersant | Hydrophobic modified | Dow Chemical |
| | polyacid Copolymer | Company |
| Orotan ™ 1288 dispersant | Polyacid | Dow Chemical |
| | | Company |
| Triton ™ CF-10 nonionic | | Dow Chemical |
| surfactant | | Company |
| Tergitol ™ 15-S-40 nonionic | | Dow Chemical |
| surfactant | | Company |
| ADVANTAGE ™ AM1512 | hydrocarbon oil | Ashland Inc. |
| Defoamer | | |
| Foamaster ™ NXZ Defoamer | | Cognis |
| Foamster ™ A 10 Defoamer | | Cognis |

Extenders used were as follows:

| Material | Chemical nature | Supplier |
|---|---|---|
| CC-1000 Extender | Calcium carbonate | Guangfu Building |
| | | Materials Group (China) |
| DB-80 Extender | Calcined clay | Jinyang Gaoling Lt. Co. |
| | | (China) |
| Talc-800 Extender | Talc | |
| CC-700 Extender | Calcium carbonate | Guangfu Building |
| | | Materials Group (China) |

Monomers were as follows:
MMA=methyl methacrylate
BA=butyl methacrylate
MAA=methacrylic acid
SSA=styrene sulfonic acid

The following Pigment Compositions were used in the following examples:

| Pigment | | Polymer | |
|---|---|---|---|
| Composition No. | TiO₂ grade | composition⁽²⁾ | weight ratio |
| PC101 | NTR-606 | 45.5 BA | polymer⁽¹⁾: 84.23 |
| (used in | | 52.5 MMA | titanium dioxide⁽¹⁾: |
| Examples 1, 3, | | | 100.00 |
| and 4) | | 1.0 MAA | water: 118.93 |
| | | 1.0 SSA | |
| | | neutralized with | |
| | | ammonia | |
| PC102 | various | 45.5 BA | polymer⁽¹⁾: 84.23 |
| (used in | | 52.5 MMA | titanium dioxide⁽¹⁾: |
| Example 2) | | | 100.00 |
| | | 1.0 MAA | water: 118.93 |
| | | 1.0 SSA | |
| | | neutralized with | |
| | | NaOH | |

Note
⁽¹⁾dry basis
Note
⁽²⁾parts by weight

### COMPARATIVE EXAMPLE CE1 AND EXAMPLE E1

Both Comparative Example CE1 and Example E1 are typical semigloss paint formulations having 25% pigment volume concentration (PVC).

The ingredients were as shown below, with amounts shown in parts by weight. For each formulation, a grind was made in a high-speed disperser.

| Grind Ingredient | CE1 | E1 |
|---|---|---|
| Water | 49.99 | |
| Triton ™ CF-10 | 0.75 | |
| Orotan ™ 1124 | 2.06 | |
| ADVANTAGE ™ AM1512 | 3.00 | |
| Rocima ™ 363 | 4.80 | |
| AMP-95 | 0.10 | |
| RCL 595 | 182.37 | |
| Water | 239.96 | 240.59 |
| Natrosol ™ 250 HBR | 5.40 | 6.00 |
| PC101 | | 442.31 |

Then, the entire contents of the grind was combined with the remaining “Let Down” ingredients with ordinary stirring.

| Let Down Ingredient | CE1 | E1 |
|---|---|---|
| AC-261 | 520.00 | 274.23 |
| Ropaque ™ Ultra E | 76.71 | 76.72 |
| ADVANTAGE ™ AM1512 | 3.00 | 3.00 |
| Propylene Glycol | 14.00 | 14.00 |
| Texanol ™ | 12.60 | 12.60 |
| Water | 49.43 | 70.00 |
| Rocima ™ 623 | 1.76 | 1.76 |

### COMPARATIVE EXAMPLES CE2-1 AND CE2-1 AND EXAMPLE E2

For CE2-1 and CD2-2, the grind and let down were made as in Example CE1. For E2, a “premix” was made instead of a grind, as shown below. Amounts are parts by weight.

| Grind or Premix Ingredient | CE2-1 | E2 | CE2-1 |
|---|---|---|---|
| water | 348.12 | | 347.55 |
| Triton ™ CF-10 | 0.75 | | 0/75 |
| Orotan ™ 1124 | 2.06 | | 2.06 |
| Foamaster ™ NXZ | 1.00 | | 1.00 |
| Natrosol ™ 250 MBR | 8.21 | | 8.21 |
| AMP-95 | 0.10 | | 0.10 |
| titanium dioxide | 182.49 | | 145.98 |
| PC102 | | 442.09 | |
| water | | 300.00 | |
| Natrosol ™ MBR | | 8.00 | |

Let Down was as follows:

| | | | |
|---|---|---|---|
| Let Down Ingredient | CE2-1 | E2 | CE2-2 |

| | | | |
|---|---|---|---|
| Primal ™ AC-261 | 489.12 | 258.91 | 489.10 |
| Ropaque ™ Ultra E | 76.76 | 76.71 | 76.76 |
| Foamaster ™ NXZ | 0.50 | 1.00 | 0.50 |
| dethylene glycol | 14.01 | 14.00 | 14.01 |
| Texanol ™ | 12.61 | 12.60 | 12.61 |
| water | 37.04 | 30.80 | 46.90 |
| Triton ™ CF-10 | | 0.75 | |
| AMP-95 | | 0.10 | |

For each formulation CE2-1, E2, and CE2-1, five versions were made, each with a different source of titanium dioxide.

### COMPARATIVE EXAMPLES CE3-1 AND CE3-2 AND EXAMPLE E3

Comparative Examples CE3-1 and CE3-2 and Example E3 are typical paint formulations having 43% pigment volume concentration (PVC).

For CE3-1 and CE3-2, the grind and let down were made as in Example CE1. For E3, a “premix” was made after a grind, as shown below. Amounts are parts by weight.

| Grind and Premix Ingredient | CE3-1 | E3 | CE3-2 |
|---|---|---|---|
| Water | 72.27 | 81.94 | 72.27 |
| Kathon ™ LXE | 1.26 | 1.26 | 1.26 |
| Orotan ™ 731A | 12.65 | 12.64 | 12.65 |
| Tergitol ™ 15-S-40 | 6.32 | 6.32 | 6.32 |
| Foamaster ™ NXZ | 0.51 | 0.51 | 0.51 |
| NTR-606 | 225.34 | | 180.27 |
| CC-1000 | 33.51 | 43.41 | 43.42 |
| DB-80 | 67.02 | 86.83 | 86.83 |
| PC101 | | 532.76 | |

Let Down was as follows:

| Let Down Ingredient | CE3-1 | E3 | CE3-2 |
|---|---|---|---|
| Primal ™ AC-261 | 468.05 | 183.98 | 468.05 |
| Ropaque ™ Ultra E | 126.45 | 126.45 | 126.45 |
| COASOL | 44.26 | 44.26 | 44.26 |
| Acrysol ™ SCT-275 | 4.53 | 5.85 | 4.53 |
| Acrysol ™ RM-2020NPR | 7.97 | 7.97 | 7.97 |
| AMP-95 | 0.18 | 0.18 | 0.18 |
| Water | 194.22 | 114.84 | 194.22 |

### COMPARATIVE EXAMPLES CE4-1 AND CE4-2 AND EXAMPLE E4

Comparative Examples CE4-1 and CE4-2 and Example E4 are typical paint formulations having 66% pigment volume concentration (PVC).

For CE4-1 and CE4-2, the grind and let down were made as in Example CE1. For E4, a “premix” was made after a grind, as shown below. Amounts are parts by weight.

| Grind and Premix Ingredient | CE4-1 | E4 | CE4-2 |
|---|---|---|---|
| Water | 490.82 | 477.24 | 490.82 |
| Natrosol ™ 250HBR | 8.18 | 8.18 | 8.18 |
| AMP-95 | 1.37 | 1.37 | 1.37 |
| Orotan ™ 1288 | 6.14 | 6.13 | 6.14 |
| Foamaster ™ NXZ | 2.05 | 2.04 | 2.05 |
| NTR-606 | 170.42 | | 136.34 |
| DB-80 | 149.97 | 159.68 | 159.66 |
| Talc-800 | 81.80 | 87.10 | 87.09 |
| CC-700 | 122.71 | 130.65 | 130.63 |
| PC101 | | 413.20 | |

Let Down was as follows:

| Let Down Ingredient | CE4-1 | E4 | CE4-2 |
|---|---|---|---|
| Water | 48.41 | 12.27 | 48.33 |
| Ethylene Glycol | 12.27 | 12.28 | 12.27 |
| Tergitol ™ 15-S-40 | 2.73 | 2.74 | 2.73 |
| Ropaque ™ Ultra E | 27.27 | 27.27 | 27.27 |
| Primal ™ SF-155 | 224.25 | | 224.25 |
| Foamster ™ A 10 | 5.45 | 5.46 | 5.45 |
| COASOL | 9.54 | 9.55 | 9.54 |

Test Results

The test procedures were as follows.

Drawdowns were made of paints with 100 μm film applicator on 5 C opacity charts and on Leneta 12H-BW brushout charts. Drawdowns were allowed to dry for 1 and/or 7 days in the controlled temperature room (25° C., 50% relative humidity).

Y-reflectance of the CIE tristimulus values was measured in three areas over both the white and black areas of the 5 C opacity chart. Contrast ratio was also be measured over the black and white portions of a Leneta 12H-BW brushout chart. To evaluate the whiteness and yellow color phase, L/a/b values were also measured on the white area of the 5 C opacity chart.

The b value from the L/a/b test is a measure of the yellowness of the coating. Higher b values show greater yellowness.

Contrast Ratio “C” is reported as the following ratio, expressed as a percentage:

C=(average reflectance over black)/(average reflectance over white).

Scattering coefficient was measured as follows. Using a Bird-style drawdown bar to give 38 μm thick wet coating, films were cast on black release charts. Also, using a drawdown block (wet film thickness 625 μm) on a black vinyl scrub chart, thick films were cast. All films were dried overnight in CT. A glass projector slide cover was placed on thin film and scored with a sharp blade to obtain the test area. (84 cm²). 5 reflectance values on the scored thin film test area were measured, and the average value was recorded. Also, 5 reflectance values on the scored thick film test area were measured, and the average value was recorded. Each film was carefully removed from the substrate and weighed. From measured reflectance values of thick and thin film and the weight of film test area, calculate hiding “S” values were calculated as follows:

$$S = {X}^{- 1} [ \frac{R}{1 - {R}^{2}} ] ln \{ \frac{( 1 - {R}_{B} R )}{( 1 - \frac{{R}_{B}}{R} )} \}$$

where X=average film thickness (found from the density, area, and weight of the film)

R=average reflectance of the thick film

R_{B}=average reflectance of the thin film

S is reported in units of number per 25.4 μm; this is referred to herein as “S/mil”.

Test results on CE1 and E1:

| | CE1 | E1 |
|---|---|---|
| Contrast ratio | 92.8% | 93.0% |
| Brightness (L/a/b) | 95.7/−0.8/1.4 | 95.8/−0.8/0.9 |

Formulations CE1 and E1 were designed to have the same hiding effectiveness, which is an important characteristic of a paint. The contrast ratios are nearly equal, which shows that the two paints do have the same hiding effectiveness. Even though the paints have the same hiding effectiveness, E1 has much lower b value, showing that E1 has much lower yellowness.

Test results for Comparative Examples CE2-1 and CE2-2 and for Example E2 were as follows. Note that the sample “E1” having TiO₂ grade R-902+ is a comparative example because it does not have sulfate-process TiO₂.

| TiO₂ grade | Property | CE2-1 | E2 | CE2-2 |
|---|---|---|---|---|
| R-902+ | C (%) | 95.50 | 95.25 | 94.27 |
| | S/mil | 7.22 | 7.16 | 6.77 |
| | L/a/b | 97.16/−0.41/0.83 | 97.1/−0.38/0.77 | 97.65/−0.42/0.90 |
| NTR-606 | C (%) | 95.03 | 96.03 | 94.60 |
| | S/mil | 7.27 | 7.31 | 6.38 |
| | L/a/b | 96.64/−0.40/0.81 | 96.85/−0.37/0.62 | 96.48/−0.38/0.87 |
| NR-950 | C (%) | 94.60 | 95.82 | 93.84 |
| | S/mil | 6.69 | 6.99 | 5.59 |
| | L/a/b | 96.37/−0.45/1.14 | 96.68/−0.38/0.82 | 96.20/−0.43/1.20 |
| BLR-699 | C (%) | 95.08 | 95.29 | 93.97 |
| | S/mil | 6.55 | 6.64 | 5.7 |
| | L/a/b | 96.26/−0.44/1.26 | 96.53/−0.37/0.97 | 96.11/−0.41/1.24 |
| ZR-960 | C (%) | 94.50 | 95.70 | 94.09 |
| | S/mil | 6.58 | 6.80 | 5.84 |
| | L/a/b | 96.36/−0.45/1.31 | 96.60/−0.40/1.00 | 96.17/−0.43/1.32 |

Wherever an E2 formulation having sulfate process titanium dioxide is compared with the CE2-1 and CE2-2 formulations made with the same grade of titanium dioxide, it is seen that the E2 sample had equal or better hiding (as shown by C and S/mil) and also had an improvement in yellowness (as shown by the b measurement)

Test results for Comparative Examples CE3-1 and CE3-2 and for Example E3 were as follows.

| TiO₂ grade | Property | CE3-1 | E3 | CE3-2 |
|---|---|---|---|---|
| NTR-606 | C (%) | 96.38 | 97.46 | 95.89 |
| | S/mil | 6.18 | 6.53 | 5.44 |
| | L/a/b | 96.90/−0.54/ | 97.11/−0.47/ | 96.55/−0.50/1.42 |
| | | 1.37 | 1.04 | |

NTR-606 is a sulfate process titanium dioxide. When Example E3 is compared to Comparative Example CE3-1, it is seen that E3 had better hiding (as shown by C and S/mil) and also had an improvement in yellowness (as shown by the b measurement), even though E3 had less titanium dioxide than CE3-1. Example E3 and Comparative Example CE3-2 have the same amount of titanium dioxide. Example E3 had better hiding (as shown by C and S/mil) and also had an improvement in yellowness (as shown by the b measurement), over CE3-2.

Test results for Comparative Examples CE4-1 and CE4-2 and for Example E4 were as follows.

| TiO₂ grade | Property | CE4-1 | E4 | CE4-2 |
|---|---|---|---|---|
| NTR-606 | C (%) | 95.28 | 96.18 | 94.53 |
| | L/a/b | 96.06/−0.41/ | 96.43/−0.35/ | 95.92/−0.38/1.66 |
| | | 1.63 | 1.32 | |

NTR-606 is a sulfate process titanium dioxide. When Example E4 is compared to Comparative Example CE4-1, it is seen that E4 had better hiding (as shown by C) and also had an improvement in yellowness (as shown by the b measurement), even though E4 has less titanium dioxide than CE4-1. Example E4 and Comparative Example CE4-2 have the same amount of titanium dioxide. Example E4 had better hiding (as shown by C) and also had an improvement in yellowness (as shown by the b measurement) over CE4-2.

1. A pigment composition comprising
(i) a plurality of particles of sulfate-process titanium dioxide,
(ii) 0.1% to 25% by weight based on the weight of said particles of a water-soluble first polymer that comprises polymerized units of one or more sulfur acid monomer, and
(iii) 10% to 200% by weight based on the weight of said particles of a second polymer that at least partially encapsulates said particles.

2. The pigment composition of claim 1 wherein said sulfur acid monomer is selected from the group consisting of sulfoethyl (meth)acrylate; 2-(meth)acrylamido-2-methylpropane sulfonic acid; styrene sulfonic acid; and vinyl sulfonic acid; mixtures thereof; and salts thereof.

3. The pigment composition of claim 1 wherein said water-soluble first polymer additionally comprises polymerized units of
one or more amine monomer selected from the group consisting of dimethylaminoethyl (meth)acrylate; dimethylaminopropyl (meth)acrylamide; and t-butylaminoethyl (meth)acrylate; and mixtures thereof; and
one or more monomer selected from the group consisting of methyl methacrylate; ethyl acrylate; butyl acrylate; 2-ethylhexyl acrylate; acrylic acid; methacrylic acid; itaconic acid; styrene; vinyl acetate; hydroxyethyl (meth)acrylate; maleic acid; and maleic anhydride, and mixtures thereof.

4. The pigment composition of claim 1 wherein said second polymer completely encapsulates said particles.

5. The pigment composition of claim 1 wherein said second polymer comprises at least two phases, wherein one polymer phase has a Tg greater than or equal to 45° C., and one polymer phase has a Tg less than or equal to 12° C.

6. The pigment composition of claim 1 wherein said second polymer comprises polymerized units of a sulfur acid monomer or a salt thereof.

7. The pigment composition of claim 1, wherein said pigment composition is a coating formulation, wherein said coating formulation additionally comprises one or more binder polymer, wherein said coating formulation comprises from 1 to 50 volume % pigment particles in the form of said particles of sulfate-process titanium dioxide, based on the total dry volume of the coating formulation, and wherein said particles of sulfate-process titanium dioxide are dispersed in an aqueous medium.

8. The pigment composition of claim 1, wherein said pigment composition additionally comprises a plurality of particles of chloride-process titanium dioxide.
